(19) United States
(12) Patent Application Publication
(10) Pub. No.: US 2006/0031430 A1
(43) Pub. Date: Feb. 9, 2006

(54) System and method of preventing computer virus infection

(76) Inventor: Beom-seok Lee, Suwon-si (KR)

Correspondence Address: STANZIONE & KIM, LLP, 919 18TH STREET, N.W., SUITE 440, WASHINGTON, DC, 20006, US

(21) Appl. No.: 11/044,071

(22) Filed: Jan. 28, 2005

(30) Foreign Application Priority Data
Feb. 16, 2004 (KR) 2004-10129

(51) Int. Cl. G06F 15/16; G06F 12/14; G06F 11/30; G06F 15/177

(52) U.S. Cl. 709/220

(57) ABSTRACT

A system and method of preventing a computer virus infection includes a first network service module which accesses update information regarding an update program to perform a particular network service, the update information being present in a network apparatus connected to the system through a network, a network service loading module which compares the update information with information regarding a program that has been stored in the system and selects one of the update program and the program to be loaded to perform the particular network service, and a second network service module which loads the selected program, to thereby perform the particular network service.

### CROSS-REFERENCE TO RELATED APPLICATIONS

This application claims the priority of Korean Patent Application No. 10-2004-10129 filed on Feb. 16, 2004 in the Korean Intellectual Property Office, the disclosure of which is incorporated herein in its entirety and by reference.

### BACKGROUND OF THE INVENTION

1. Field of the Invention

The present general inventive concept relates to a system and method of preventing a computer virus infection, and more particularly, to a system and method of preventing a computer from becoming infected with a computer virus when the computer accesses a network, by checking information regarding a program to perform a predetermined network service between a client and a server.

2. Description of the Related Art

Network services generally provide a particular function for a program object within a current computer or within another computer connected to a network. The network services include a File Transfer Protocol (FTP), a Domain Name System (DNS), a Dynamic Host Configuration Protocol (DHCP), a web server, a Remote Procedure Call (RPC), a Distributed Component Object Model (DCOM), etc.

Among these network services, the RPC and the DCOM, which allow a client program object in one computer to request a service to be offered to a server program object in another computer through a network, are very vulnerable to a computer virus infection through the network and have been attacked by a great number of worm viruses. In other words, when a general operating system (OS) starts operating, a variety of processes which can provide the above-described network services are automatically loaded, and therefore, the OS is readily exposed to the computer virus infection through the network. Moreover, since a great variety of the network services exist, it cannot be predicted what kinds of faults will occur.

An automatically replicating computer virus is propagated via programs within an infected system and through the network to other systems and usually performs malicious actions such as destroying the systems and disturbing a normal operation. Since an infection usually occurs due to a fault in the OS, updating the OS is a conventional method to prevent a virus infection.

In other words, FIG. 1 illustrates an example of a conventional method of updating a program. The program may be an OS, a network application module for performing a particular network service, one of various network service modules or a sub program module included therein.

For example, an OS provider provides various update programs through an update server 130 over the Internet. To update the program related with a network service in a client 110, i.e., a computer, a user 100 accesses the update server 130 through a network 120. FIG. 2 illustrates a logical structure of the client 110 performing the network service.

When an OS starts in the client 110, a network service module 210 is automatically loaded and executed. The network service module 210 interacts with a network driver 220, which controls a network device 230, thereby accessing the update server 130 through the network 120 in order to execute or update a particular program. In addition, even after the start of the OS, the client 110 can access the update server 130 through a network application module 200 (for example, a web browser) which performs a particular function using network services provided by the network service module 210.

Notwithstanding the conventional updating methods which are currently available, as shown in FIGS. 1 and 2, many users do not pay attention to updating. Moreover, even if the user 100 connects the client 110 to the network 120 to visit an update site, an infection may occur within several seconds through the network 120 so that even an update cannot be performed. In addition, an infection may occur during downloading of the update program or while the downloaded update program is being installed in the client 110.

### SUMMARY OF THE INVENTION

The present general inventive concept provides a system and method of preventing computer virus infection through a network by changing a method of loading a network service module in an OS which operates a system.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a system to prevent computer virus infection, the system comprising a first network service module to access update information regarding an update program to perform a particular network service, the update information and the update program residing in a network apparatus connected to the system through a network, a network service loading module to compare the update information with information regarding a program stored in the system and to select one of the update program and the program stored in the system to be loaded to perform the particular network service, and a second network service module to load the selected program, to thereby perform the particular network service.

When the update information is newer than the information regarding the program stored in the system, the network service loading module can allow the first network service module to download the update program corresponding to the update information and allow the second network service module to load the downloaded update program.

When the update information is the same as the information regarding the program stored in the system, the network service loading module can allow the second network service module to load the stored program.

The information may be program version information.

The foregoing and/or other aspects and advantages of the present general inventive concept may also be achieved by providing a method of preventing computer virus infection, the method comprising, controlling a first network apparatus to access a second network apparatus to access first update information regarding an update program to perform a particular network service without loading a program stored in the first network apparatus during system initialization, allowing the first network apparatus to compare second update information regarding the program, which is already possessed by the first network apparatus, with the first update information, allowing the first network apparatus to download and install the update program corresponding to the first update information from the second network apparatus when the first update information is newer than the second update information, and allowing the first network apparatus to load the update program to perform the particular network service.

When the first update information is the same as the second update information, the method may further comprise allowing the first network apparatus to load the possessed program to perform the particular network service.

The information may be program version information.

When the first update information is newer than the second update information, the downloading and installing of the update program may comprise providing a user interface comprising an update information display area, in which information regarding the update program is displayed, and an update execution area allowing a user to execute an update, and when the user selects a predetermined update icon included in the update execution area, controlling the first network apparatus to download and install the update program corresponding to the first update information from the second network apparatus.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates an example of a conventional method of updating a program;

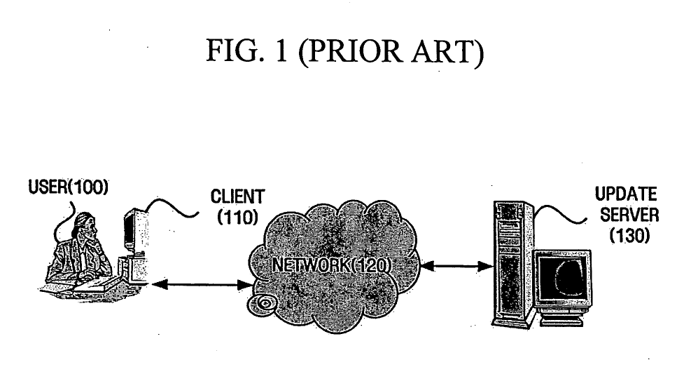

FIG. 2 illustrates a conventional logical structure of a client performing a network service;

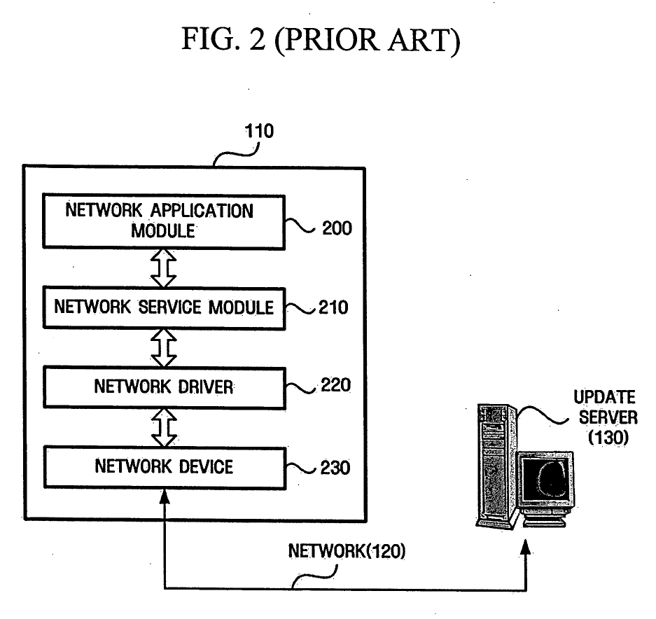

FIG. 3 illustrates a logical structure of a client performing a network service according to an embodiment of the present general inventive concept;

FIG. 4 illustrates a method of a client to perform a network service according to an embodiment of the present general inventive concept;

FIG. 5 illustrates a method of determining whether to update a program in the method of FIG. 4; and

FIG. 6 illustrates a user interface to determine whether to update the program in the method of FIGS. 4 and 5.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

When a system which operates according to a predetermined operating system (OS) is turned on, a system initialization including a system booting can be performed. Here, when the system provides various network services, the system loads programs to perform the network services. The programs may include a network service program to substantially provide a network service, such as an “.exe” or “.dll”, and a network application module program to perform a particular function using the network service. Hereinafter, the program to substantially provide the network service is referred to as a network service module.

The network service module may be infected with a computer virus through a network. To prevent such a computer virus infection, a company that provides the system or the OS used in the system can store an update program that is not infected with a computer virus, and information regarding the update program in a particular server. This particular server is referred to as an update server.

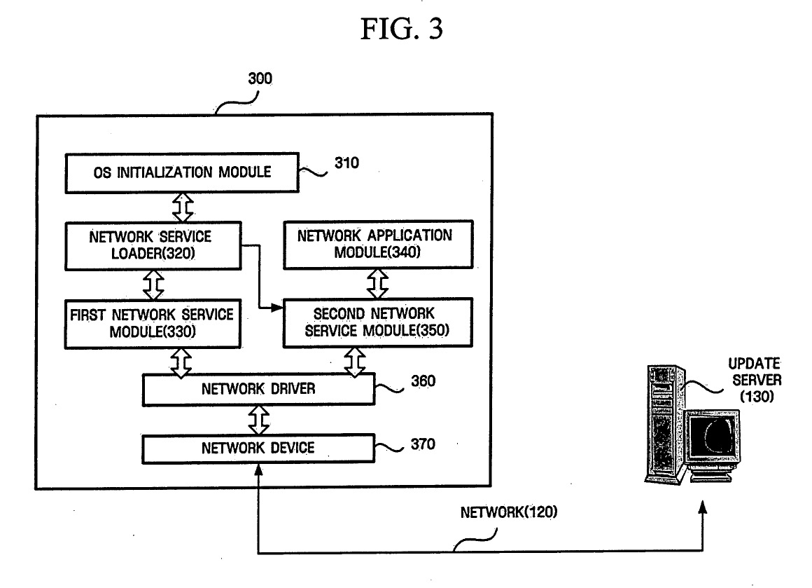

Referring to FIG. 3, in an embodiment of the present general inventive concept, a client 300 may include a first network service module 330 and a second network service module 350.

The first network service module 330 does not provide a network service to network apparatuses other than the client 300 on a network 120 but can be capable of downloading only information regarding an update program from an update server 130. In some cases, if a system specification permits, the first network service module 330 may also be capable of downloading the update program. For example, when the update server 130 is used as a web server, the first network service module 330 may be implemented to provide only Transmission Control Protocol/Internet Protocol (TCP/IP) and Hypertext Transfer Protocol (HTTP) services. The second network service module 350 can be a program module to substantially perform the network service.

The following description concerns detailed operations of a logical structure shown in FIG. 3.

When the client 300 is started by a user, an OS initialization module 310 operates to initialize the system. The OS initialization module 310 can call a network service loader 320, to thereby operate the first network service module 330. In other words, without loading network service modules which are vulnerable or possibly vulnerable to an attack of a computer virus through the network 120, the first network service module 330 is used to verify whether a program installed in the client 300 to perform a predetermined network service has been updated in the update server 130. When it is verified that the program has been updated in the updated server 130, the client 300 can download the update program from the updated server 130 and install the update program. The download and the installation can be managed by the network service loader 320. Thereafter, the network service loader 320 can transmit a result of the managing of the downloading and installation to the second network service module 350 so that the second network service module 350 can perform the update program.

However, when the client 300 verifies, based on the information regarding the update program, which is stored in the update server 130, that the program has not been updated, the network service loader 320 manages the second network service module 350 to perform the program installed in the client 300.

The first and second network service modules 330 and 350 can interact with a network driver 360, which can control a network device 370 to thereby access the update server 130 through the network 120. The client 300 can access the update server 130 through a network application module 340 (for example, a web browser) which can perform a particular function using network services provided by the second network service module 350.

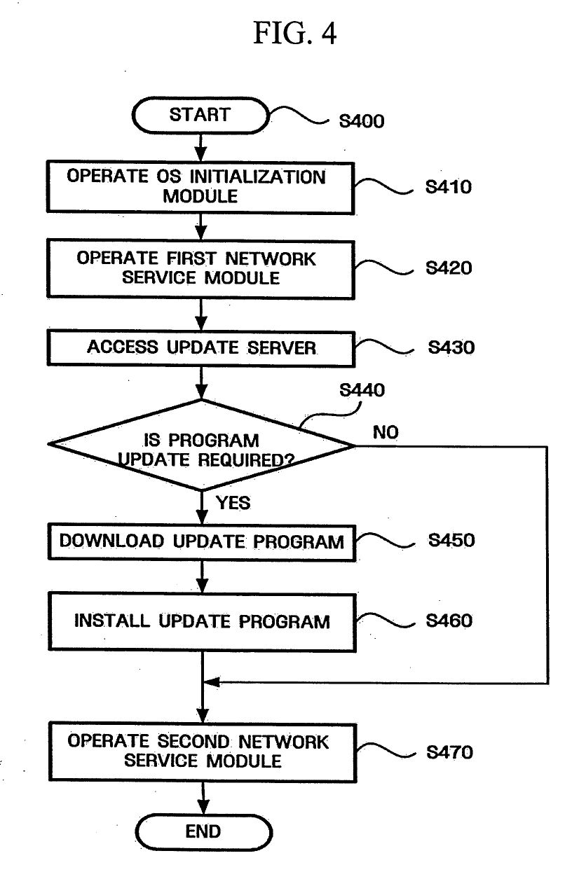

FIG. 4 illustrates a method used by a client to perform a network service according to an embodiment of the present general inventive concept.

Referring to FIGS. 3 and 4, a user starts the client 300 in operation S400, the OS initialization module 310 operates in operation S410. In other words, when UNIX or Linux is used as an OS, if the client 300 is booted, a variety of processes are loaded and participate in OS initialization. In a conventional method, processes to provide a network service are automatically loaded. However, in this embodiment of the present general inventive concept, during the OS initialization, the processes to provide the network service are not immediately loaded, but the first network service module 330 is operated in operation S420. Then, the first network service module 330 can access the update server 130 through the network 120 to access the information regarding the update program to perform a predetermined network service in operation S430.

In operation S440, the client 300 can determine whether the program stored in the client 300 to perform the particular network service needs to be updated. If the client 300 determines that the program stored in the client 300 to perform the particular network service needs to be updated as a result of analyzing the information regarding the update program, the client 300 can download the update program from the update server 130 in operation S450. Next, the client 300 can install the downloaded update program in operation S460, so that an environment to perform the particular network service provided by the update program can be established. Then, the second network service module 350 can be operated to provide the particular network service in operation S470.

If the client 300 determines that the program does not need to be updated in operation S440, the second network service module 350 can be operated to execute the program installed in the client 300 in operation S470 so that the particular network service provided by the program can be performed.

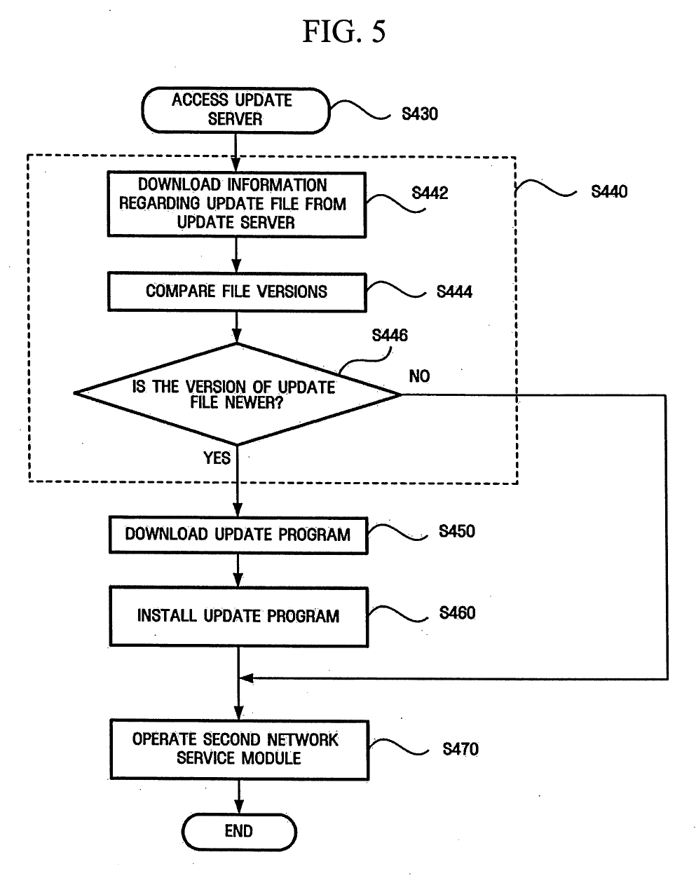

FIG. 5 illustrates a method of determining whether to update the program in the method of FIG. 4.

A dotted box in FIG. 5 illustrates an example of operation S440 shown in FIG. 4, i.e., a method of determining whether the program update is required. Operations outside of the dotted box in FIG. 5 are the same as those shown in FIG. 4.

After the client 300 accesses the update server 130 in operation S430, the client 300 can download the information regarding the update program from the update server 130 in operation S442. The update program may be a program file or a file describing information on the update program, and the information may be about a file version.

In operation S444, the client 300 can compare the information of a file version corresponding to the update program with a version of an existing file corresponding to the program that has been installed in the client 300. In operation S446, if the version of the update program stored in the update server 130 is newer than the version of the existing file in the client 300, the update program can be downloaded from the update server 130 in operation S450. If the version of the update program is not newer than that of the existing file, the program that has been installed in the client 300 can be loaded so that the network service performed by the program is provided.

The operations after operation S446 are the same as operations S450 through S470 shown in FIG. 4.

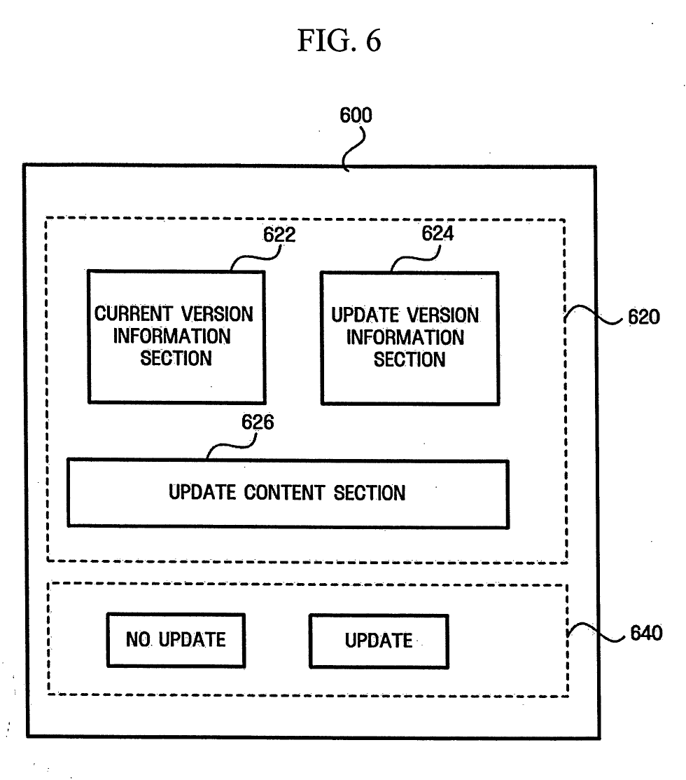

Meanwhile, if in operation S446, the version of the update program stored in the update server 130 is newer than that of the program installed in the client 300, the client 300 may automatically download and install the update program, but alternatively, a user may be asked whether to download the update program using a user interface 600 as shown in FIG. 6.

Referring to FIGS. 4-6 user interface 600 shown in FIG. 6 may include an update information display area 620, in which the information regarding the update program, i.e., update information, can be displayed to a user, and an update execution area 640, in which a program update can be executed by the user. Program version information may be used as the update information.

The update information display area 620 may include a current version information section 622 where version information regarding a current program possessed by the client 300 can be displayed and an update version information section 624 where version information regarding an update program stored in the update server 130 can be displayed. The update information display area 620 may further include an update content section 626 where an update content is described in detail when the version of the update program is newer than the version of the current program. In addition, the update execution area 640 may include an Update icon and a No update icon so that the user can select the Update icon when the user wants to update the program or the No update icon when the user does not want to update the program.

Accordingly, after checking the version information and the update content, the user can allow the client 300 to update the program using the Update icon in the update execution area 640.

According to the present general inventive concept, an infection with a known computer virus through a network can be effectively prevented without a user's manual operation. Therefore, a client can securely use network services.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of preventing a computer virus infection during accessing a network or updating a program, the method comprising:
accessing update information regarding an update program to perform a particular network service during a system initialization of a first network apparatus;
comparing information regarding a program of the first network apparatus with the update information;
downloading and installing the update program corresponding to the update information from a second network apparatus when first update information is newer than the information; and
loading the update program to perform the particular network service.

2. The method of claim 1, further comprising:
allowing the first network apparatus to load the possessed program and perform the particular network service when the first update information is not newer than the second update information.

3. The method of claim 1, wherein the update information comprises program version information.

4. The method of claim 1, wherein downloading and installing of the update program comprises:
providing a user interface comprising an update information display area to display information regarding the update program, and an update execution area to allow a user to execute an update, when the first update information is newer that the second update information;
allowing the user to select a predetermined update icon included in the update execution area; and
allowing the first network apparatus to download and install the update program corresponding to the first update information from the second network apparatus.

5. The method of claim 1, wherein the first network apparatus and the second network apparatus are connected to each other through a network, and the accessing of the update information comprises controlling the first network apparatus to access the second network apparatus through the network to access the update information.

6. The method of claim 1, wherein the accessing of the update information comprises receiving the update information from the second network apparatus through a network.

7. The method of claim 1, wherein the accessing of the update information comprises receiving a file version as the update information, and the comparing of the information comprises comparing the file version with another file version relating to the information.

8. The method of claim 1, wherein the accessing of the update information comprises preventing the first network apparatus from loading the program until it is determined that the update information is not newer than the information.

9. The method of claim 1, wherein the accessing of the update information comprises controlling the first network apparatus to access the second network apparatus to access the update information during the system initialization without loading the program stored in the first network apparatus.

10. The method of claim 1, wherein the downloading and installing of the update program comprises providing a user interface through which one of the update program and the program is selected during the system initialization.

11. The method of claim 1, wherein the downloading and installing of the update program comprises providing a user interface to be displayed on a screen so that one of the update program of the second network apparatus and the program of the first network apparatus is selected to perform the particular network service during the system initialization.

12. The method of claim 1, wherein the accessing of the update information comprises accessing the second network apparatus to receive the update information when the first network apparatus is turned on.

13. The method of claim 1, wherein the accessing of the update information comprises accessing the second network apparatus to receive the update information when an OS (operating system) is turned on to start the system initialization.

14. A system to prevent a computer virus infection, comprising:
a first network service module to access update information regarding an update program to perform a particular network service, the update information and the update program residing in an external network apparatus connected thereto through a network;
a network service loading module to compare the update information with information regarding a program to select one of the update program and the program to be loaded to perform the particular network service; and
a second network service module to load the selected program to perform the particular network service.

15. The system of claim 14, wherein when the update information is newer than the information regarding the program stored in the system, the network service loading module allows the first network service module to download the update program corresponding to the update information and allows the second network service module to load the downloaded program.

16. The system of claim 14, wherein when the update information is the same as the information regarding the program stored in the system, the network service loading module allows the second network service module to load the stored program.

17. The system of claim 14, wherein the information is program version information.

18. The system of claim 14, wherein the first network service module provides Transmission Control Protocol/Internet Protocol (TCP/IP) and Hypertext Transfer Protocol (HTTP) services.

19. The system of claim 14, wherein the first network service module is controlled to access the external network apparatus to receive the update information when the system is turned on.

20. The system of claim 14, wherein the first network service module is controlled to access the external network apparatus to receive the update information during a system initialization.

21. The system of claim 14, further comprising:
an OS initialization module to control the first network service module to access the update information when the OS initialization module is turned on.

22. The system of claim 14, wherein the second network service module is prevented from loading the program during a system initialization until the selected program is determined.

23. The system of claim 14, further comprising:
a network application module to store the program, wherein the second network service module does not load the program until the selected program is determined.

24. A method of preventing a computer virus infection during accessing a network or updating a program, the method comprising:
accessing update information regarding an update program to perform a particular network service, the update information and the update program residing in an external network apparatus connected thereto through a network;
comparing the update information with information regarding a program to select one of the update program and the program to be loaded to perform the particular network service; and
loading the selected program to perform the particular network service.

25. A system to prevent a computer virus infection during accessing a network or updating a program, comprising:
a first network service module to receive an update program from an external network apparatus connected through a network during a system initialization; and
a second network service module to load one of the update program and an existing program according to a status of the update program to perform a particular network service.

26. A method of preventing a computer virus infection during accessing a network or updating a program, the method comprising:
receiving an update program from an external network apparatus connected through a network during a system initialization; and
loading one of the update program and an existing program according to a status of the update program to perform a particular function.
